(19) United States
(12) Patent Application Publication
(10) Pub. No.: US 2026/0235197 A1
(43) Pub. Date: Aug. 13, 2026

(54) MECHANICAL COMPONENT AND METHOD FOR MANUFACTURING MECHANICAL COMPONENT

(71) Applicant: KOMATSU LTD., Tokyo (JP)

(72) Inventor: Daigo KANAZAWA, Tokyo (JP)

(73) Assignee: KOMATSU LTD., Tokyo (JP)

(21) Appl. No.: 19/156,243

(22) PCT Filed: Dec. 26, 2023
(86) PCT No.: PCT/JP2023/046643

§ 371 Date: Aug. 13, 2025

(30) Foreign Application Priority Data
Mar. 7, 2023 (JP) 2023-034868

(51) Int. Cl. F16H 55/06; C21D 1/18; C21D 1/74; C21D 6/00; C21D 9/32; C22C 38/00; C22C 38/02; C22C 38/04; C22C 38/18; C23C 8/14; C23C 8/22; C23C 8/80

(52) U.S. Cl. CPC F16H 55/06; C21D 1/18; C21D 1/74; C21D 6/002; C21D 9/32; C22C 38/002; C22C 38/02; C22C 38/04; C22C 38/18; C23C 8/14; C23C 8/22; C23C 8/80; C21D 2211/008

(57) ABSTRACT

A spur gear as a mechanical component is made of steel containing 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, with the balance being iron and inevitable impurities, and having a martensitic structure, and includes a carburized layer disposed so as to constitute at least a part of a surface and having a higher carbon concentration than the other portion. The carburized layer includes a composite oxide film disposed so as to constitute the surface, having a thickness of 1 μm or more and 25 μm or less, and containing magnetite and hematite.

### TECHNICAL FIELD

The present disclosure relates to a mechanical component and a method for manufacturing the mechanical component.

This application claims priority based on Japanese Patent Application No. 2023-034868 filed on Mar. 7, 2023, the entire contents of which are incorporated herein by reference.

### BACKGROUND ART

In a mechanical component made of steel, a carburized layer having a higher carbon concentration than other portions may be formed to constitute a surface from the viewpoint of improving strength. The mechanical component having the carburized layer and quench-hardened has a high hardness of a surface layer portion. On the other hand, the region other than the carburized layer has low hardness and excellent toughness. As a result, the mechanical component having the carburized layer can achieve both strength and toughness.

The carburized layer is generally formed by gas carburization. In gas carburization, carbon (C) is generated in a reaction in which two molecules of carbon monoxide (CO) are converted to one molecule of carbon dioxide (CO₂) on the surface of the mechanical component, and the carbon is supplied to the surface of the mechanical component. Gas carburization is an excellent treatment method in that carburizing can be performed at low cost. On the other hand, since carbon dioxide is produced in the above reaction, there is a problem that a large amount of carbon dioxide is discharged in the carburizing treatment.

Vacuum carburization is known as another carburizing method. In vacuum carburization, the mechanical component is heated in a reduced-pressure atmosphere (for example, at a pressure of 1 kPa or less), and carbon produced by the decomposition reaction of hydrocarbons such as acetylene (C₂H₂) on the surface of the mechanical component is supplied to the surface of the mechanical component. Vacuum carburization generally requires a higher equipment cost than gas carburization, but has advantages of shortening the treatment time, reducing the production cost, and avoiding the emission of a large amount of carbon dioxide. Steel suitable for vacuum carburizing, mechanical components having excellent characteristics by forming the carburized layer by vacuum carburizing, and the like have been proposed (for example, see JP 2022-080369 A (Patent Document 1), WO 2020/144830 (Patent Document 2), and JP 2006-183095 A (Patent Document 3)).

### CITATION LIST

### Patent Literature

Patent Document 1: JP 2022-080369 A
Patent Document 2: WO 2020/144830
Patent Document 3: JP 2006-183095 A

### SUMMARY OF INVENTION

### Technical Problem

As mentioned in the above patent documents, a mechanical component having the carburized layer formed by vacuum carburization has the characteristics that formation of a grain boundary oxide layer on the surface is suppressed as compared with a mechanical component having the carburized layer formed by gas carburization. In general, it is considered that the properties such as fatigue strength (life) of the mechanical component are improved by suppressing the formation of the grain boundary oxide layer.

However, according to the study of the present inventors, in the mechanical component in which the carburized layer is formed by vacuum carburization, a phenomenon (white layer peeling) in which a white layer is generated and peeling occurs on the surface may occur in a short period of time as compared with the mechanical component in which the carburized layer is formed by gas carburization.

One object of the present disclosure is to provide a mechanical component having improved durability by suppressing occurrence of white layer peeling, and a method for manufacturing the mechanical component.

### Solution to Problem

A mechanical component according to a first aspect of the present disclosure is made of steel containing 0.12 mass % or more and 0.28 mass % or less of carbon (C), 0.15 mass % or more and 0.70 mass % or less of silicon(S), 0.20 mass % or more and 0.95 mass % or less of manganese (Mn), and 0.85 mass % or more and 1.90 mass % or less of chromium (Cr), with the balance being iron and inevitable impurities, and having a martensitic structure. The mechanical component includes a carburized layer disposed so as to constitute at least a part of a surface and having a higher carbon concentration than the other portion. The carburized layer includes a composite oxide film disposed so as to constitute the surface, having a thickness of 1 μm or more and 25 μm or less, and containing magnetite (Fe₃O₄) and hematite (Fe₂O₃).

A mechanical component according to a second aspect of the present disclosure is made of steel containing 0.12 mass % or more and 0.28 mass % or less of carbon, 0.15 mass % or more and 0.70 mass % or less of silicon, 0.20 mass % or more and 0.95 mass % or less of manganese, 0.85 mass % or more and 1.90 mass % or less of chromium, and at least one selected from the group consisting of 0.15 mass % or more and 0.45 mass % or less of molybdenum (Mo), 0.01 mass % or more and 2.00 mass % or less of nickel (Ni), and 0.04 mass % or more and 0.08 mass % or less of niobium (Nb), with the balance being iron and inevitable impurities, and having a martensitic structure. The mechanical component includes a carburized layer disposed so as to constitute at least a part of a surface and having a higher carbon concentration than the other portion. The carburized layer includes a composite oxide film disposed so as to constitute the surface, having a thickness of 1 μm or more and 25 μm or less, and containing magnetite and hematite.

A method for manufacturing a mechanical component according to a first aspect of the present disclosure includes a step of preparing a steel material, a step of obtaining a compact, a step of forming a composite oxide film, a step of forming a carburized layer, and a step of quench-hardening the compact. In the step of preparing a steel material, a steel material containing 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, with the balance being iron and inevitable impurities, is prepared. In the step of obtaining a compact, the compact is obtained by forming the steel material. In the step of forming a composite oxide film, the compact is heated in an oxidizing atmosphere, and a composite oxide film containing magnetite and hematite is formed on the surface of the compact. In the step of forming a carburized layer, the compact on which the composite oxide film is formed is heated in a carburizing atmosphere at a pressure of 1 kPa or less, thereby forming, on the surface of the compact, a carburized layer having a higher carbon concentration than the other portion with a thickness thicker than the composite oxide film. In the step of quench-hardening the compact, the compact having the composite oxide film and the carburized layer formed thereon is quench-hardened.

A method for manufacturing a mechanical component according to a second aspect of the present disclosure includes a step of preparing a steel material, a step of obtaining a compact, a step of forming a composite oxide film, a step of forming a carburized layer, and a step of quench-hardening the compact. In the step of preparing a steel material, a steel material containing 0.12 mass % or more and 0.28 mass % or less of carbon, 0.15 mass % or more and 0.70 mass % or less of silicon, 0.20 mass % or more and 0.95 mass % or less of manganese, 0.85 mass % or more and 1.90 mass % or less of chromium, and at least one selected from the group consisting of 0.15 mass % or more and 0.45 mass % or less of molybdenum, 0.01 mass % or more and 2.00 mass % or less of nickel, and 0.04 mass % or more and 0.08 mass % or less of niobium, with the balance being iron and inevitable impurities, is prepared. In the step of obtaining a compact, the compact is obtained by forming the steel material. In the step of forming a composite oxide film, the compact is heated in an oxidizing atmosphere, and a composite oxide film containing magnetite and hematite on the surface of the compact is formed. In the step of forming a carburized layer, the compact on which the composite oxide film is formed is heated in a carburizing atmosphere at a pressure of 1 kPa or less, thereby forming, on the surface of the compact, a carburized layer having a higher carbon concentration than the other portion with a thickness thicker than the composite oxide film. In the step of quench-hardening the compact, the compact having the composite oxide film and the carburized layer formed thereon is quench-hardened.

### Advantageous Effects of Invention

According to the mechanical component and the method for manufacturing the mechanical component, it is possible to provide a mechanical component and a method for manufacturing the mechanical component in which the durability is improved by suppressing the occurrence of white layer peeling.

### BRIEF DESCRIPTION OF DRAWINGS

FIG. 1 is a schematic perspective view illustrating an appearance of a spur gear according to a first embodiment.

FIG. 2 is a schematic cross-sectional view illustrating a cross-sectional structure of the spur gear according to the first embodiment.

FIG. 3 is a schematic cross-sectional view illustrating the structure of a carburized layer according to the first embodiment.

FIG. 4 is a flowchart schematically illustrating a method for manufacturing the spur gear according to the first embodiment.

FIG. 5 is a diagram illustrating heat treatment performed in the method for manufacturing the spur gear according to the first embodiment.

FIG. 6 is a schematic cross-sectional view illustrating a structure of a carburized layer of a spur gear according to a second embodiment.

FIG. 7 is a flowchart schematically illustrating a method for manufacturing the spur gear according to the second embodiment.

FIG. 8 is a diagram illustrating heat treatment performed in the method for manufacturing the spur gear according to the second embodiment.

FIG. 9 is a schematic cross-sectional view illustrating a structure of a carburized layer of a spur gear according to a third embodiment.

FIG. 10 is a flowchart schematically illustrating the method for manufacturing the spur gear according to the third embodiment.

FIG. 11 is a flowchart schematically illustrating a method for manufacturing a spur gear according to a fourth embodiment.

FIG. 12 is a diagram illustrating heat treatment performed in the method for manufacturing the spur gear according to the fourth embodiment.

FIG. 13 is a schematic perspective view illustrating an appearance of a bevel pinion.

FIG. 14 is a diagram showing a relationship between the thickness of a composite oxide film and the incidence of a white layer.

FIG. 15 is a diagram showing results of X-ray diffraction analysis of the composite oxide film.

FIG. 16 is a diagram showing results of X-ray diffraction analysis of an oxide film formed by gas carburization.

FIG. 17 is a diagram illustrating a method of a dedendum bending fatigue test.

FIG. 18 is a diagram showing results of a surface pressure strength test.

FIG. 19 is a diagram showing results of the dedendum bending fatigue test.

FIG. 20 is a diagram showing results of a dedendum bending impact test.

FIG. 21 is a diagram showing results of a Charpy impact test.

### DESCRIPTION OF EMBODIMENTS

### Summary of Embodiment

A mechanical component according to a first aspect of the present disclosure is made of steel containing 0.12 mass % or more and 0.28 mass % or less of carbon (C), 0.15 mass % or more and 0.70 mass % or less of silicon(S), 0.20 mass % or more and 0.95 mass % or less of manganese (Mn), and 0.85 mass % or more and 1.90 mass % or less of chromium (Cr), with the balance being iron and inevitable impurities, and having a martensitic structure. The mechanical component includes a carburized layer disposed so as to constitute at least a part of a surface and having a higher carbon concentration than the other portion. The carburized layer includes a composite oxide film disposed so as to constitute the surface, having a thickness of 1 μm or more and 25 μm or less, and containing magnetite (Fe₃O₄) and hematite (Fe₂O₃).

A mechanical component according to a second aspect of the present disclosure is made of steel containing 0.12 mass % or more and 0.28 mass % or less of carbon, 0.15 mass % or more and 0.70 mass % or less of silicon, 0.20 mass % or more and 0.95 mass % or less of manganese, 0.85 mass % or more and 1.90 mass % or less of chromium, and at least one selected from the group consisting of 0.15 mass % or more and 0.45 mass % or less of molybdenum (Mo), 0.01 mass % or more and 2.00 mass % or less of nickel (Ni), and 0.04 mass % or more and 0.08 mass % or less of niobium (Nb), with the balance being iron and inevitable impurities, and having a martensitic structure. The mechanical component includes a carburized layer disposed so as to constitute at least a part of a surface and having a higher carbon concentration than the other portion. The carburized layer includes a composite oxide film disposed so as to constitute the surface, having a thickness of 1 μm or more and 25 μm or less, and containing magnetite and hematite.

The present inventors have studied a measure for suppressing the occurrence of white layer peeling in a mechanical component having a carburized layer formed by vacuum carburization. As a result, the inventors have found that the occurrence of the white layer peeling can be suppressed by forming a composite oxide film having a predetermined thickness or more, more specifically, a thickness of 1 μm or more, and containing magnetite and hematite so as to constitute the surface of the carburized layer. The reason why the occurrence of the white layer peeling is suppressed is not limited to the following, but it can be considered that the reason is as follows, for example.

The white layer peeling is considered to occur as follows. First, a new surface is generated on the surface of the mechanical component due to contact with another component or the like. When lubricant oil comes into contact with the new surface, hydrocarbons contained in the lubricant oil are decomposed, and hydrogen generated by the decomposition enters the surface layer portion of the mechanical component, thereby forming a white layer. The white layer serves as a starting point to cause a crack in the mechanical component, and thus damage (white layer peeling) occurs on the surface of the mechanical component in a short time.

In contrast, the occurrence of the white layer peeling can be suppressed by forming a composite oxide film having a thickness of a predetermined thickness or more (specifically, 1 μm or more) and containing magnetite and hematite so as to constitute the surface of the carburized layer. The reasons for this are considered to be, for example, that the presence of the composite oxide film suppresses the formation of the above-described new surface, and that the composite oxide film is appropriately shaved off at a contact portion with another mechanical component when the mechanical component is newly incorporated into a machine and starts operating, thereby absorbing an error in the shape of the mechanical component (improving initial conformity). It is known that an oxide film (grain boundary oxide layer) is formed so as to constitute a surface also in a carburized layer formed by gas carburization. However, the oxide film formed in the gas carburization is an oxide film composed of a single phase of magnetite, and is an oxide film different from the above-described composite oxide film.

In general, one of the most important merits of employing vacuum carburization for the formation of a carburized layer is that an oxide film (grain boundary oxide layer) is not formed in the surface layer portion. On the contrary, the present inventors have found that the occurrence of the white layer peeling can be suppressed by intentionally forming a composite oxide film containing magnetite and hematite on the surface of the carburized layer. In order to sufficiently exhibit the function of suppressing the occurrence of the white layer peeling, the thickness of the composite oxide film needs to be 1 μm or more. On the other hand, if the thickness of the composite oxide film exceeds 25 μm, the above-described function is saturated, whereas the bending strength, torsional strength, and the like of the mechanical component are reduced, and the manufacturing cost increases. Therefore, the thickness of the composite oxide film needs to be 25 μm or less.

In the mechanical component according to the present disclosure, the carburized layer includes a composite oxide film disposed to form a surface, having a thickness of 1 μm or more and 25 μm or less, and containing magnetite and hematite. As a result, according to the mechanical component according to the present disclosure, it is possible to provide a mechanical component having improved durability by suppressing the occurrence of white layer peeling.

Hereinafter, the reasons for limiting the component composition of the steel constituting the mechanical component of the present disclosure to the above range will be described.

### Carbon: 0.12 Mass % or More and 0.28 Mass % or Less

The carbon content has a great influence on the hardness of the steel with a martensitic structure (quench-hardened steel). From the viewpoint of ensuring sufficient hardness of a base portion, which is a region other than the carburized layer, and suppressing the carburizing treatment time required to provide a sufficient carbon content in the carburized layer, the carbon content needs to be 0.12 mass % or more. On the other hand, if the carbon content of the base portion is high, the toughness of the mechanical component is reduced. From the viewpoint of ensuring sufficient toughness, the carbon content needs to be 0.28 mass % or less.

### Silicon: 0.15 Mass % or More and 0.70 Mass % or Less

Silicon contributes to improvement of hardenability and temper softening resistance. From the viewpoint of ensuring such a function, the silicon content needs to be 0.15 mass % or more. On the other hand, if the silicon content is excessive, the workability such as machinability tends to decrease. From the viewpoint of enabling easy processing, the silicon content needs to be 0.70 mass % or less. From the viewpoint of workability, the silicon content is preferably 0.35 mass % or less. From the viewpoint of hardenability and temper softening resistance, the silicon content is preferably 0.45 mass % or more.

### Manganese: 0.20 Mass % or More and 0.95 Mass % or Less

Manganese contributes to improvement of hardenability. From the viewpoint of ensuring such a function, the manganese content needs to be 0.20 mass % or more. On the other hand, if the manganese content is excessive, the amount of retained austenite after quenching tends to increase. From the viewpoint of appropriately controlling the amount of retained austenite, the manganese content needs to be 0.95 mass % or less. From the viewpoint of the hardenability, the manganese content is preferably 0.40 mass % or more. From the viewpoint of more appropriately controlling the amount of retained austenite, the manganese content is preferably 0.40 mass % or less.

### Chromium: 0.85 Mass % or More and 1.90 Mass % or Less

Chromium is an element that improves hardenability. From the viewpoint of ensuring sufficient hardenability, the chromium content needs to be 0.85 mass % or more. On the other hand, if the chromium content is excessive, toughness is reduced. Therefore, the chromium content needs to be 1.90 mass % or less. Chromium has a function of facilitating the refinement of carbides. From the viewpoint of sufficiently ensuring such a function, the chromium content is preferably 1.70 mass % or more. On the other hand, from the viewpoint of ensuring the toughness, the chromium content is preferably 1.30 mass % or less.

### Inevitable Impurities

In addition to the components intentionally added in the manufacturing process, elements other than those mentioned above may be contained as inevitable impurities in the steel constituting the mechanical component. For example, oxygen (O) is reduced as much as possible by deoxidization treatment, but is inevitably contained in steel. Oxygen may form non-metallic inclusions in steel and may adversely affect the properties of mechanical components. Therefore, the oxygen content is preferably 20 ppm or less. It is also preferable that the other impurity elements are reduced as much as possible within a reasonable manufacturing cost range. The total amount of the inevitable impurities is preferably 1.00 mass % or less.

### Molybdenum: 0.15 Mass % or More and 0.45 Mass % or Less

Molybdenum is not an element that is necessarily added intentionally. However, molybdenum contributes to the improvement of hardenability and temper softening resistance. In order to obtain such a function, the molybdenum content is preferably 0.15 mass % or more. On the other hand, molybdenum is an expensive element, and excessive addition thereof leads to an increase in cost. From the viewpoint of not increasing the cost more than necessary, the molybdenum content is preferably 0.45 mass % or less.

### Nickel: 0.01 Mass % or More and 2.00 Mass % or Less

Nickel is not an element that is necessarily added intentionally. However, nickel contributes to the improvement of toughness. In order to obtain such a function, the nickel content is preferably 0.01 mass % or more. On the other hand, nickel is an expensive element, and excessive addition thereof leads to an increase in cost. From the viewpoint of not increasing the cost more than necessary, the nickel content is preferably 2.00 mass % or less. From the viewpoint of cost reduction, the nickel content is preferably 0.75 mass % or less, and more preferably 0.25 mass % or less. On the other hand, from the viewpoint of improving the toughness, the nickel content is preferably 0.35 mass % or more, and more preferably 1.55 mass % or more.

### Niobium: 0.04 Mass % or More and 0.08 Mass % or Less

Niobium is not an element that is necessarily added intentionally. However, niobium contributes to the refinement of crystal grains. In order to obtain such a function, the niobium content is preferably 0.04 mass % or more. On the other hand, even if niobium is added in an amount exceeding 0.08 mass %, the above effect is saturated. Therefore, the niobium content is preferably 0.08 mass % or less.

In the mechanical component described above, the carburized layer may have a thickness of 500 μm or more. This configuration makes it easy to provide the mechanical component with sufficient strength.

In the mechanical component described above, the maximum carbon concentration in the thickness direction of the carburized layer may be 0.6 mass % or more. This configuration makes it easy to impart sufficient hardness to the surface layer portion of the mechanical component.

In the carburized layer of the above-described mechanical component, the maximum carbon concentration in the thickness direction may be 0.8 mass % or more and 1.2 mass % or less. In the carburized layer, the maximum grain size of the carbides in a cross section orthogonal to the surface may be 1 μm or less. In the carburized layer, the grain size number defined in JIS G0551 may be 12 or more. As described above, by setting the maximum carbon concentration of the carburized layer to be high, dispersing fine carbides in the carburized layer, and refining the crystal grains, both the strength and the toughness can be achieved at a high level. In the carburized layer, an area ratio of the carbide in a cross section orthogonal to the surface may be 1% or more and 10% or less. In the carburized layer, the average grain size of the carbides in a cross section orthogonal to the surface may be 1 μm or less.

In the carburized layer of the mechanical component, the maximum carbon concentration in the thickness direction may be 1.1 mass % or more and 1.8 mass % or less. In the carburized layer, the maximum grain size of the carbide in a cross section orthogonal to the surface may be 25 μm or less. In the carburized layer, the grain size number defined in JIS G0551 may be 11 or more. As described above, by setting the maximum carbon concentration of the carburized layer to be high and refining the crystal grains, it is possible to achieve both durability against surface damage (for example, pitting resistance) and toughness at a high level. In the carburized layer, the area ratio of the carbide in a cross section orthogonal to the surface may be 3% or more and 30% or less.

In the carburized layer of the mechanical component, the maximum nitrogen concentration in the thickness direction may be 0.7 mass % or more and 1.2 mass % or less. By causing nitrogen to infiltrate into the carburized layer and ensuring an appropriate amount of retained austenite, the pitting resistance is greatly improved. In the carburized layer, the maximum amount of retained austenite in the thickness direction may be 50 volume % or more and 70 volume % or less.

The mechanical component may be a component constituting a transmission, an axle, a final drive, or a swing machinery of a work machine. The mechanical component of the present disclosure having improved durability by suppressing the occurrence of white layer peeling is suitable as these components.

A method for manufacturing a mechanical component according to a first aspect of the present disclosure includes a step of preparing a steel material, a step of obtaining a compact, a step of forming a composite oxide film, a step of forming a carburized layer, and a step of quench-hardening the compact. In the step of preparing a steel material, a steel material containing 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, with the balance being iron and inevitable impurities, is prepared. In the step of obtaining a compact, the compact is obtained by forming the steel material. In the step of forming a composite oxide film, the compact is heated in an oxidizing atmosphere, and a composite oxide film containing magnetite and hematite is formed on the surface of the compact. In the step of forming a carburized layer, the compact on which the composite oxide film is formed is heated in a carburizing atmosphere at a pressure of 1 kPa or less, thereby forming, on the surface of the compact, a carburized layer having a higher carbon concentration than the other portion with a thickness thicker than the composite oxide film. In the step of quench-hardening the compact, the compact having the composite oxide film and the carburized layer formed thereon is quench-hardened.

A method for manufacturing a mechanical component according to a second aspect of the present disclosure includes a step of preparing a steel material, a step of obtaining a compact, a step of forming a composite oxide film, a step of forming a carburized layer, and a step of quench-hardening the compact. In the step of preparing a steel material, a steel material containing 0.12 mass % or more and 0.28 mass % or less of carbon, 0.15 mass % or more and 0.70 mass % or less of silicon, 0.20 mass % or more and 0.95 mass % or less of manganese, 0.85 mass % or more and 1.90 mass % or less of chromium, and at least one selected from the group consisting of 0.15 mass % or more and 0.45 mass % or less of molybdenum, 0.01 mass % or more and 2.00 mass % or less of nickel, and 0.04 mass % or more and 0.08 mass % or less of niobium, with the balance being iron and inevitable impurities, is prepared. In the step of obtaining a compact, the compact is obtained by forming the steel material. In the step of forming a composite oxide film, the compact is heated in an oxidizing atmosphere, and a composite oxide film containing magnetite and hematite is formed on the surface of the compact. In the step of forming a carburized layer, the compact on which the composite oxide film is formed is heated in a carburizing atmosphere at a pressure of 1 kPa or less, thereby forming, on the surface of the compact, a carburized layer having a higher carbon concentration than the other portion with a thickness thicker than the composite oxide film. In the step of quench-hardening the compact, the compact having the composite oxide film and the carburized layer formed thereon is quench-hardened.

According to the method for manufacturing a mechanical component according to the present disclosure, the mechanical component of the present invention described above can be easily manufactured.

In the method for manufacturing a mechanical component according to the present disclosure, the step of forming the composite oxide film and the step of forming the carburized layer may be alternately repeated a plurality of times. This allows carbon introduced into the compact in the step of forming the carburized layer to be diffused inside the compact in the subsequent step of forming the composite oxide film. As a result, the formation of the composite oxide film and the formation of the carburized layer can be efficiently performed.

In the method for manufacturing a mechanical component according to the present disclosure, in the step of forming the carburized layer, the carburized layer may be formed such that the maximum carbon concentration in the thickness direction is 0.8 mass % or more and 1.2 mass % or less. The method for manufacturing a mechanical component may further include, before the step of quench-hardening the compact, a step of cooling the compact having the carburized layer formed thereon from a temperature range of an A1 transformation point or higher to a temperature range lower than the A1 transformation point, thereby forming the carburized layer into a pearlitic structure, and a step of heating the compact having the carburized layer formed into the pearlitic structure to the temperature range of the A1 transformation point or higher and then cooling the compact to the temperature range lower than the A1 transformation point, thereby spheroidizing the carbides contained in the carburized layer and refining the crystal grains of the carburized layer. After the step of quench-hardening the compact, the maximum grain size of carbides in the carburized layer in a cross section orthogonal to the surface of the compact may be 1 μm or less, and the grain size number of the carburized layer defined in JIS G0551 may be 12 or more. This makes it possible to easily manufacture a mechanical component that achieves both strength and toughness at a high level. In the carburized layer after the step of quench-hardening the compact, an area ratio of carbide in a cross section orthogonal to the surface may be 1% or more and 10% or less. In the carburized layer after the step of quench-hardening the compact, the average grain size of carbides in a cross section orthogonal to the surface may be 1 μm or less.

In the method for manufacturing a mechanical component according to the present disclosure, in the step of forming the carburized layer, the carburized layer may be formed such that the maximum carbon concentration in the thickness direction is 1.1 mass % or more and 1.8 mass % or less. The method for manufacturing a mechanical component may further include, before the step of quench-hardening the compact, a step of cooling the compact having the carburized layer formed thereon to the temperature range lower than the A1 transformation point, thereby forming the carburized layer into a pearlitic structure, and a step of heating the compact having the carburized layer formed into the pearlitic structure to the temperature range of the A1 transformation point or higher and then cooling the compact to the temperature range lower than the A1 transformation point, thereby spheroidizing the carbides contained in the carburized layer. After the step of quench-hardening the compact, the maximum grain size of carbides in the carburized layer in a cross section orthogonal to the surface of the compact may be 25 μm or less, and the grain size number of the carburized layer defined in JIS G0551 may be 11 or more. Accordingly, a mechanical component that achieves both durability against surface damage (for example, pitting resistance) and toughness at a high level can be easily manufactured. After the step of quench-hardening the compact, the area ratio of carbides in the carburized layer in a cross section orthogonal to the surface may be 3% or more and 30% or less.

The method for manufacturing a mechanical component according to the present disclosure may further include, before the quench-hardening of the compact, heating the compact in a nitriding atmosphere, thereby causing nitrogen to infiltrate into the carburized layer. Accordingly, the mechanical component having the carburized layer containing nitrogen can be easily manufactured.

### EXAMPLES OF SPECIFIC EMBODIMENTS

Next, specific embodiments of the mechanical component of the present disclosure will be described with reference to the drawings. In the following drawings, the same components or equivalent components are denoted by the same reference signs, and descriptions thereof are not repeated.

### First Embodiment

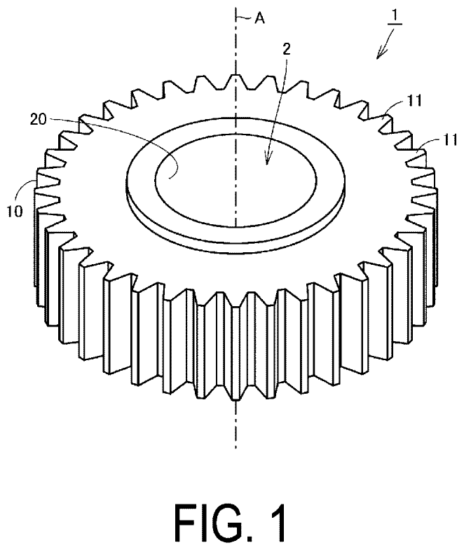

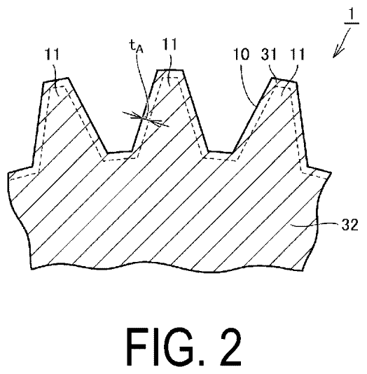

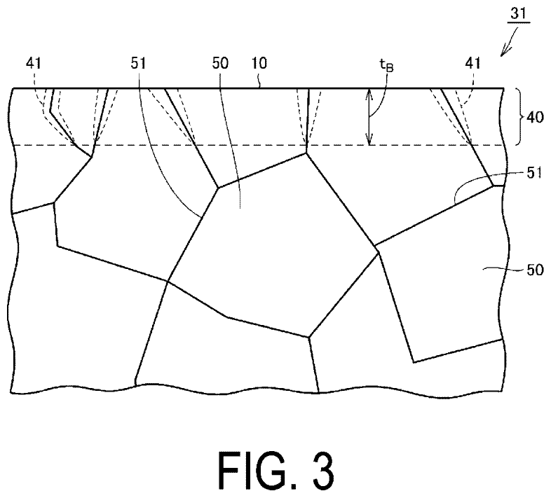

First, a spur gear according to a first embodiment, which is an example of a mechanical component according to the present disclosure, will be described with reference to FIGS. 1 to 3. FIG. 1 is a schematic perspective view illustrating the appearance of the spur gear according to the first embodiment. FIG. 2 is a schematic cross-sectional view illustrating a cross-sectional structure of the spur gear according to the first embodiment. FIG. 3 is a schematic cross-sectional view illustrating the structure of a carburized layer according to the first embodiment. FIG. 2 illustrates a cross-section orthogonal to a central axis A of FIG. 1. FIG. 3 illustrates the structure of steel constituting the vicinity of the surface of the carburized layer.

Referring to FIG. 1, a spur gear 1 in the first embodiment is a gear constituting a planetary gear mechanism. The spur gear 1 has an annular shape (hollow cylindrical shape). A through hole 2 is formed in the spur gear 1 along the central axis. A plurality of teeth 11 that engage with teeth of a sun gear and an outer gear of the planetary gear mechanism are formed on an outer circumferential surface 10 of the spur gear 1 over the entire region in the circumferential direction. An inner circumferential surface 20 surrounding the through hole 2 has a cylindrical shape. A shaft of a carrier of the planetary gear mechanism is inserted into the through hole 2. The spur gear 1 can be used as a component constituting, for example, a final drive or a swing machinery of a hydraulic excavator, a transmission or a final drive of a bulldozer, a transmission or a final drive of a dump truck, or the like, which are work machines.

The spur gear 1 is made of steel having a martensitic structure, which contains 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, with the balance being iron and inevitable impurities. The spur gear 1 may be made of steel having a martensitic structure, the steel containing 0.12 mass % or more and 0.28 mass % or less of carbon, 0.15 mass % or more and 0.70 mass % or less of silicon, 0.20 mass % or more and 0.95 mass % or less of manganese, 0.85 mass % or more and 1.90 mass % or less of chromium, and at least one selected from the group consisting of 0.15 mass % or more and 0.45 mass % or less of molybdenum, 0.01 mass % or more and 2.00 mass % or less of nickel, and 0.04 mass % or more and 0.08 mass % or less of niobium, with the balance being iron and inevitable impurities.

Referring to FIG. 2, the spur gear 1 includes a carburized layer 31 which is disposed to constitute the outer circumferential surface 10 having teeth 11 formed thereon and has a higher carbon concentration than a base portion 32 which is the other portion. The thickness t_{A} of the carburized layer 31 may be, for example, 500 μm or more, or may be 800 μm or more. The maximum carbon concentration in the thickness direction of the carburized layer 31 (the direction orthogonal to the outer circumferential surface 10) may be 0.6 mass % or more. The carburized layer 31 is formed over the entire region of the outer circumferential surface 10. The carburized layer 31 is formed so as to cover the entire surface of the teeth 11.

Referring to FIG. 3, the carburized layer 31 has a structure in which a large number of prior austenite crystal grains 50 are laid all over. The boundary between the adjacent prior austenite crystal grains 50 is a crystal grain boundary 51. In the present embodiment, a grain boundary oxidized region 41 which is a region where oxygen infiltrates from the outer circumferential surface 10 along the crystal grain boundary 51, is formed. The grain boundary oxidized region 41 is composed of a composite oxide containing magnetite and hematite. In the present application, the surface layer portion in which the grain boundary oxidized region 41 composed of the composite oxide is formed is defined as a composite oxide film 40. The thickness t_{B} of the composite oxide film 40 is 1 μm or more and 25 μm or less. That is, the carburized layer 31 in the present embodiment includes the composite oxide film which is disposed so as to constitute the outer circumferential surface 10 that is the surface of the spur gear 1, which has the thickness of 1 μm or more and 25 μm or less, and which contains magnetite and hematite. The grain size number of the carburized layer 31 defined by JIS G0551 (hereinafter also simply referred to as “grain size number”) is, for example, 8. The maximum carbon concentration in the thickness direction of the carburized layer 31 is, for example, 0.68 mass % or more and 0.80 mass % or less. Carbides (cementites) are not substantially dispersed in the carburized layer 31. Here, the state in which cementites are not substantially dispersed refers to a state in which, for example, when ten square regions with sides of 20 μm are examined in a cross section of a carburized layer at a magnification of 5000 times using a SEM (Scanning Electron Microscope), the number of cementite particles found is one or less.

In the spur gear 1 which is the mechanical component of the present embodiment, the carburized layer 31 includes the composite oxide film 40 which is disposed to constitute the outer circumferential surface 10 that is the surface of the spur gear 1, which has the thickness of 1 μm or more and 25 μm or less, and which contains magnetite and hematite. As a result, the spur gear 1 of the present embodiment is a mechanical component having improved durability by suppressing the occurrence of white layer peeling.

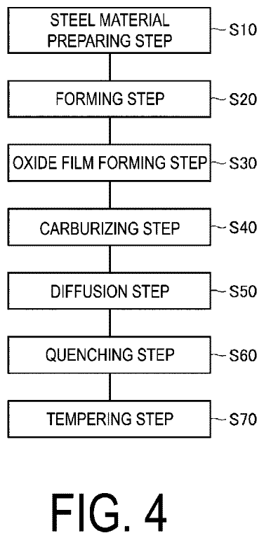

Next, an example of a method of manufacturing the spur gear 1, which is the mechanical component of the present embodiment, will be described. FIG. 4 is a flowchart schematically illustrating a method for manufacturing a spur gear. Referring to FIG. 4, in the method of manufacturing the spur gear 1 of the present embodiment, a steel material preparing step is first performed as a step S10. In the step S10, a steel material made of steel constituting the spur gear 1 of the present embodiment is prepared.

Specifically, a steel material containing 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, with the balance being iron and inevitable impurities, is prepared. In the step S10, a steel material containing 0.12 mass % or more and 0.28 mass % or less of carbon, 0.15 mass % or more and 0.70 mass % or less of silicon, 0.20 mass % or more and 0.95 mass % or less of manganese, 0.85 mass % or more and 1.90 mass % or less of chromium, and at least one selected from the group consisting of 0.15 mass % or more and 0.45 mass % or less of molybdenum, 0.01 mass % or more and 2.00 mass % or less of nickel, and 0.04 mass % or more and 0.08 mass % or less of niobium, with the balance being iron and inevitable impurities, may be prepared. As the steel material prepared in the process S10, for example, JIS standard SCr420H, SCM415H, SCM418H, SCM420H, SCM425H, SCM822H, SNCM220H, SNCM420H, and the like can be adopted.

Next, a forming step is performed as a step S20. In the step S20, the steel material prepared in the step S10 is formed to obtain a compact. In particular, the steel material prepared in the step S10 is processed, thereby manufacturing a compact having the shape of the spur gear 1. As the process in the step S20, for example, hot-forging, cold-forging, cutting and the like can be performed.

Next, an oxide film forming step is performed as a step S30. In the step S30, the compact manufactured in the step S20 is heated in an oxidizing atmosphere, whereby the composite oxide film 40 containing magnetite and hematite is formed on the surface (outer circumferential surface 10) of the compact (spur gear 1).

Next, the carburization step is performed as the step S40. In the step S40, the compact (spur gear 1) on which the composite oxide film 40 is formed in the step S30 is heated in a carburizing atmosphere at a pressure of 1 kPa or less, so that the carburized layer 31 having a higher carbon concentration than the base portion 32, which is the other portion, is formed on the surface (outer circumferential surface 10) of the spur gear 1 with a thickness thicker than the composite oxide film 40.

Next, a diffusion step is performed as a step S50. In the step S50, the compact (spur gear 1) on which the carburized layer 31 is formed in the step S40 is held in a temperature range of the A1 transformation point or higher, so that carbons that have infiltrated into the vicinities of the surface of the spur gear 1 in the step S40 diffuse into the interior. As a result, the carbon concentration in the carburized layer 31 is leveled out and the thickness of the carburized layer 31 is increased.

Next, the quenching step is performed as the step S60. In this step S60, the compact (spur gear 1) on which the composite oxide film 40 is formed in the step S30 and on which the carburized layer 31 is formed in the step S40 is quench-hardened. To be specific, the spur gear 1 on which the composite oxide films 40 and the carburized layers 31 are formed are quench-hardened by being cooled (rapidly cooled) from the temperature range of the A1 transformation point or higher to a temperature range of an MS point or lower.

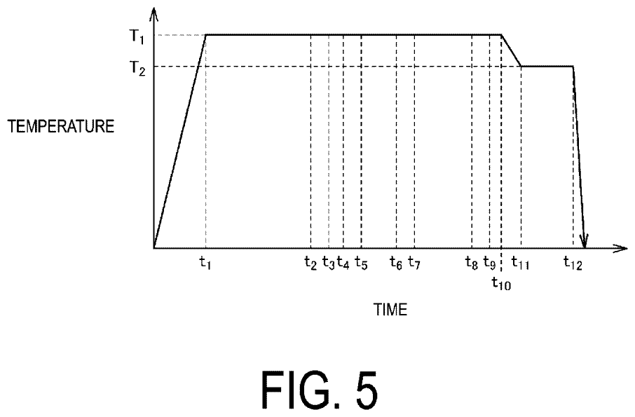

Here, details of specific examples of the steps S30 to S60 will be described with reference to FIG. 5. FIG. 5 is a diagram illustrating heat treatment performed in the method for manufacturing the spur gear according to the first embodiment. In FIG. 5, the horizontal axis corresponds to time. Time elapses as it goes to the right on the horizontal axis. In FIG. 5, the vertical axis corresponds to the heating temperature of the compact (spur gear 1). The heating temperature increases as the position goes up on the vertical axis.

Referring to FIGS. 5 and 4, the oxide film forming step is first performed as the step S30. Specifically, as illustrated in FIG. 5, first, the spur gear 1 is heated to temperature T₁ by time t₁. The temperature T₁ is the temperature of the A1 transformation point (727° C.) or more, and can be the temperature of 930° C. or more and 980° C. or less, for example, 950° C. At this time, the spur gear 1 is heated in an oxidizing atmosphere containing at least one of oxygen (O₂) and carbon dioxide (CO₂) and having a moisture content less than the dew point, and is held at the temperature T₁ from time t₁ to time t₂. As the oxidizing atmosphere, for example, dry air can be adopted. The time period from time t₁ to time t₂ may be, for example, 120 minutes. The pressure of the atmosphere may be 100 kPa or less, for example 40 kPa. As a result, the composite oxide film 40 containing magnetite and hematite is formed on the surface of the spur gear 1 (the surface of the tooth 11). More specifically, oxygen infiltrates along the austenite grain boundary of the steel constituting the spur gear 1, and the grain boundary oxidized region 41 constituted by a composite oxide containing magnetite and hematite is formed.

Next, the carburization step is performed as the step S40. Specifically, as illustrated in FIG. 5, during a period from time t₂ to time t₃, the spur gear 1 is heated in a carburizing atmosphere at a pressure of 1 kPa or less, thereby forming the carburized layer 31. As the carburizing atmosphere, for example, an acetylene atmosphere of hydrocarbon can be adopted. The time period from time t₂ to time t₃ may be shorter than the time period from time t₁ to time t₂, and may be 10 minutes, for example.

Next, in the present embodiment, the step S30 is performed again. In the present embodiment, the step S30 of forming the composite oxide film and the step S40 of forming the carburized layer are alternately repeated a plurality of times (specifically, four times). Specifically, as illustrated in FIG. 5, during a period from time t₃ to time t₄, the spur gear 1 is held at the same temperature T₁ in the same atmosphere as those during a period from time t₁ to time t₂. Accordingly, oxygen further infiltrates along the austenite grain boundary of the steel constituting the spur gear 1, and the thickness of the composite oxide film 40 increases. The time from the time t₃ to time t₄ may be shorter than the time from the time t₁ to time t₂, for example, five minutes. At this time, the carbon that has infiltrated near the surface of the spur gear 1 during the period from time t₂ to time t₃ diffuses into the spur gear 1. This increases the thickness of the carburized layer 31 and levels the carbon concentration in the thickness direction of the carburized layer. That is, the step S40 performed after the step S30 is performed also functions as a diffusion step of carbons.

Next, the step S40 is performed again. Specifically, as illustrated in FIG. 5, during a period from time t₄ to time t₅, the spur gear 1 is held at the same temperature T₁ in the same atmosphere as those during the period from time t₂ to time t₃. As a result, carbon further infiltrates from the surface of the spur gear 1, and thus the carburized layer 31 is formed. The time period from time t₄ to time t₅ may be the same as the time period from time t₂ to time t₃, for example, 10 minutes.

Next, the step S30 is performed again. Specifically, as illustrated in FIG. 5, during a period from time t₅ to time t₆, the spur gear 1 is held at the same temperature T₁ in the same atmosphere as those during the period from time t₃ to time t₄. Accordingly, oxygen further infiltrates from the surface of the spur gear 1, and thus the thickness of the composite oxide film 40 increases. The time period from time t₅ to time t₆ may be longer than the time period from time t₃ to time t₄ and may be shorter than the time period from time t₁ to time t₂, for example, 20 minutes.

Next, the step S40 is performed again. Specifically, as illustrated in FIG. 5, during a period from time t₆ to time t₇, the spur gear 1 is held at the same temperature T₁ in the same atmosphere as those during the period from time t₂ to time t₃. As a result, carbon further infiltrates from the surface of the spur gear 1, and thus the carburized layer 31 is formed. The time period from time t₆ to time t₇ may be the same as the time period from time t₂ to time t₃, for example, 10 minutes.

Next, the step S30 is performed again. Specifically, as illustrated in FIG. 5, during a period from time t₇ to time t₈, the spur gear 1 is held at the same temperature T₁ in the same atmosphere as those during the period from time t₃ to time t₄. Accordingly, oxygen further infiltrates from the surface of the spur gear 1, and thus the thickness of the composite oxide film 40 increases. The time period from time t₇ to time t₅ may be longer than the time period from time t₅ to time t₆ and may be shorter than the time period from time t₁ to time t₂, for example, 50 minutes.

Next, the step S40 is performed again. Specifically, as illustrated in FIG. 5, during a period from time t₅ to time t₆, the spur gear 1 is held at the same temperature T₁ in the same atmosphere as those during the period from time t₂ to time t₃. As a result, carbon further infiltrates from the surface of the spur gear 1, and thus the carburized layer 31 is formed. The time period from time t₅ to time t₆ may be shorter than the time period from time t₂ to time t₃, for example, four minutes. The carburizing step from time t₅ to time t₆ functions as a step of compensating for decarburization occurred in the oxide film forming step from time t₇ to time t₈, that is, a recarburization step.

Next, the step S50 is performed. Specifically, during the period from time t₉ to time t₁₀, the temperature is held at the same temperature T₁ as that during the period from time t₅ to time to in an inert gas atmosphere (for example, in an argon gas atmosphere or a nitrogen gas atmosphere). At this time, the carbon that has entered the vicinity of the surface of the spur gear 1 diffuses into the spur gear 1. This increases the thickness of the carburized layer 31 and levels the carbon concentration in the thickness direction of the carburized layer. The time period from time t₉ to time t₁₀ may be shorter than the time period from time t₅ to time t₉, and may be, for example, one minute.

Next, the step S60 is performed. To be specific, as illustrated in FIG. 5, during a period from time t₁₀ to time t₁₁, the temperature of spur gear 1 is cooled from the temperature T₁ to temperature T₂, for example, 850° C., which is lower than the temperature T₁ and higher than the A1 transformation point. Thereafter, the spur gear 1 is held at the temperature T₂ for a time period from time t₁₁ to time t₁₂, and then cooled (rapidly cooled) to the temperature of the MS point or lower. Thereby, the spur gear 1 is quench-hardened, and the structure of the steel constituting the spur gear 1 becomes a state having a martensitic structure.

Referring to FIG. 4, a tempering step is performed as a step S70. In this step S70, the compact (spur gear 1) quench-hardened by the step S60 is subjected to tempering treatment. To be specific, the spur gear 1 is heated to a temperature lower than the A1 transformation point, for example, to a temperature range of 150° C. or more and 200° C. or less (for example, 160° C.), and then cooled to room temperature. The spur gear 1 of the present embodiment can be manufactured by the above procedure.

### Second Embodiment

A second embodiment, which is another embodiment of the present disclosure, will be described. The spur gear 1 in the second embodiment basically has the same structure as the spur gear 1 in the first embodiment and achieves the same effects. However, the spur gear 1 of the second embodiment is different from that of the first embodiment mainly in the structure of the carburized layer 31. The differences from the first embodiment will be described below.

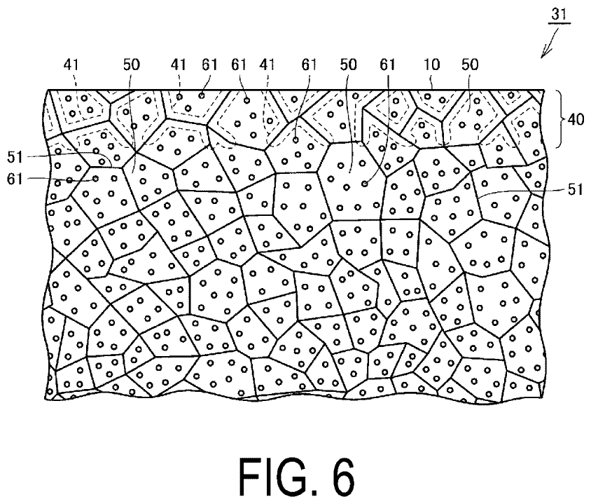

FIG. 6 is a schematic cross-sectional view illustrating a structure of a carburized layer of a spur gear according to the second embodiment. Referring to FIG. 6, in the carburized layer 31 of the spur gear 1 in the second embodiment, the maximum carbon concentration in the thickness direction of the carburized layer 31 is 0.8 mass % or more and 1.2 mass % or less. A large number of carbides 61 (cementite) are dispersed in the carburized layer 31. The maximum grain size of the carbide 61 in the cross section of the carburized layer 31 (cross section in FIG. 6) orthogonal to the outer circumferential surface 10, which is the surface of the spur gear 1, is 1 μm or less. Further, in the carburized layer 31, the grain size number is 12 or more. The area ratio of the carbides 61 in the cross section of FIG. 6 may be 1% or more and 10% or less. The average grain size of the carbides 61 in the cross section of FIG. 6 may be 1 μm or less. Here, the area ratio, the maximum grain size and the average grain size of the carbide 61 in the carburized layer 31 can be grasped by, for example, using an SEM to measure the area ratio, the maximum grain size and the average grain size of cementite found when 10 square regions each having a side of 20 μm are examined at a magnification of 5000 times in the cross section of the carburized layer.

As the steel constituting the spur gear 1, for example, steel having a larger chromium content than that in the first embodiment may be adopted. As the steel constituting the spur gear 1 of the second embodiment, for example, steel containing 0.22 mass % or more and 0.26 mass % or less of carbon, 0.45 mass % or more and 0.70 mass % or less of silicon, 0.20 mass % or more and 0.40 mass % or less of manganese, 1.70 mass % or more and 1.90 mass % or less of chromium, and 0.04 mass % or more and 0.08 mass % or less of niobium, with the balance being iron and inevitable impurities, can be adopted.

As described above, by setting the maximum carbon concentration of the carburized layer 31 to be high, dispersing the fine carbides 61 in the carburized layer 31 at an appropriate area ratio, and refining the prior austenite crystal grains 50, the spur gear 1 of the second embodiment is a mechanical component having both strength and toughness at high levels.

Next, a method for manufacturing the spur gear 1 according to the second embodiment will be described. The spur gear 1 in the second embodiment can be manufactured basically in the same procedure as the spur gear 1 in the first embodiment. However, in the method of manufacturing the spur gear 1 of the second embodiment, the manufacturing method is partially different from that of the first embodiment in order to obtain the characteristic structure of the carburized layer 31. The differences from the first embodiment will be described below.

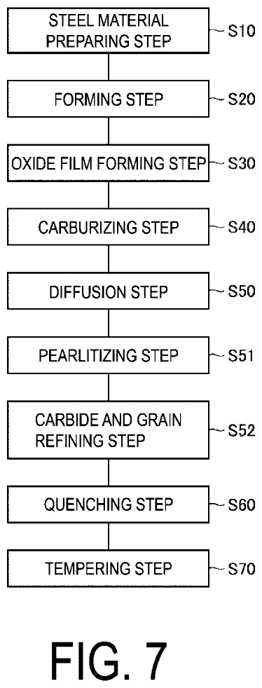

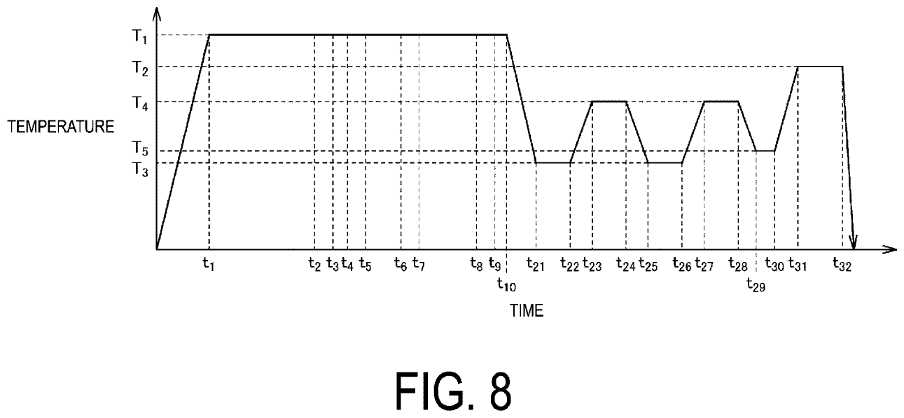

FIG. 7 is a flowchart schematically illustrating the method for manufacturing the spur gear according to the second embodiment. FIG. 8 is a diagram illustrating heat treatment performed in the method for manufacturing the spur gear according to the second embodiment. FIGS. 7 and 8 correspond to FIGS. 4 and 5 in the first embodiment, respectively.

Referring to FIG. 7, first, as in the first embodiment, the steel material preparing step is performed as the step S10. In the method for manufacturing the spur gear in the second embodiment, a steel material containing, for example, 0.22 mass % or more and 0.26 mass % or less of carbon, 0.45 mass % or more and 0.70 mass % or less of silicon, 0.20 mass % or more and 0.40 mass % or less of manganese, 1.70 mass % or more and 1.90 mass % or less of chromium, and 0.04 mass % or more and 0.08 mass % or less of niobium, with the balance being iron and inevitable impurities, may be prepared.

Next, the step S20 is performed in the same manner as in the first embodiment. Thereafter, referring to FIGS. 7 and 8, the steps S30 to S50 (until time t₁₀ in FIG. 8) are performed in the same manner as in the first embodiment. Here, in the step S40, the carburization time is set longer than that in the first embodiment, whereby the carburized layer 31 having a higher carbon concentration than that in the first embodiment is formed. Specifically, the carburized layer 31 is formed such that the maximum carbon concentration in the thickness direction is 0.8 mass % or more 1.2 mass % or less.

Next, a pearlitizing step is performed as a step S51. In this step, the compact (spur gear 1) on which the carburized layer 31 is formed is cooled from a temperature range of the A1 transformation point or higher to a temperature range of lower than the A1 transformation point. Thereby, the carburized layer 31 is formed into a pearlitic structure. To be specific, referring to FIG. 8, during a period from time t₁₀ to time t₂₁, the spur gear 1 is cooled from the temperature T₁ of the A1 transformation point or higher to temperature T₃ lower than the A1 transformation point, and is held until time t₂₂. The temperature T₃ may be, for example, 650° C.

Next, a step of refining carbides and grains is performed as a step S52. In this step S52, the compact (spur gear 1) having the carburized layer 31 with a pearlitic structure is heated to the temperature range of the A1 transformation point or higher and then cooled to the temperature range lower than the A1 transformation point, whereby carbides contained in the carburized layer 31 are spheroidized and grains of the carburized layer 31 are refined. To be specific, referring to FIG. 8, during a period from time t₂₂ to time t₂₃, the spur gear 1 is heated from the temperature T₃, which is a temperature lower than the A1 transformation point, to temperature T₄, which is a temperature of the A1 transformation point or higher, and is held until time t₂₄. The temperature T₄ may be temperature lower than the temperature T₁, for example, 810° C. As a result, lamellar carbides constituting the pearlitic structure are divided, and a large number of fine carbide nuclei are formed. Further, the structure of the steel is austenitized again at the temperature T₄, whereby fine austenite crystal grains can be obtained. Thereafter, the spur gear 1 is cooled to the temperature T₃ during a period from time t₂₄ to time t₂₅, and is held until time t₂₆. As a result, the nuclei grow due to the precipitated carbides, and a large number of fine spherical carbides are formed. In addition, the steel structure having fine prior austenite crystal grains 50 can be obtained.

In the present embodiment, the spur gear 1 is heated again from the temperature T₃ to the temperature T₄ during a period from time t₂₆ to time t₂₇, and is held until time t₂₈. As a result, the remaining lamellar carbides are divided, and a large number of fine carbide nuclei are formed. Further, the structure of the steel is austenitized again at the temperature T₄, whereby fine austenite crystal grains can be obtained. Thereafter, the spur gear 1 is cooled to temperature T₅ during a period from time t₂₈ to time t₂₉, and is held until the time t₃₀. The temperature T₅ may be higher than temperature T₃ and lower than the A1 transformation point, for example, 700° C. As a result, the nuclei grow due to the precipitated carbides, and a large number of fine spherical carbides are further formed. In addition, the steel structure having fine prior austenite crystal grains 50 can be obtained.

Next, the quenching step is performed as the step S60. In the step S60, the compact (spur gear 1) subjected to the steps up to the step S52 is quench-hardened. Specifically, referring to FIG. 8, the spur gear 1 is heated from the temperature T₅ to the temperature T₂ during a period from time t₃₀ to time t₃₁. The temperature T₂ may be higher than the temperature T₅ and lower than the temperature T₁, for example, 850° C. Thereafter, the spur gear 1 is held at the temperature T₂ for a time period from time t₃₁ to time t₃₂, and then cooled (rapidly cooled) to the temperature of the MS point or lower. Thereby, the spur gear 1 is quench-hardened, and the structure of the steel constituting the spur gear 1 becomes a state having a martensitic structure.

At this time, in the present embodiment, the maximum grain size of the carbides 61 in the carburized layer 31 in the cross section orthogonal to the outer circumferential surface 10, which is the surface of the compact (spur gear 1), is 1 μm or less. Further, the grain size number of the carburized layer 31 is 12 or more. Further, the area ratio of the carbides 61 in the carburized layer 31 in the cross section orthogonal to the outer circumferential surface 10 can be set to 1% or more and 10% or less, and the average grain size of the carbides 61 can be set to 1 μm or less.

Thereafter, the tempering step is performed as the step S70 in the same manner as in the first embodiment. The spur gear 1 of the present embodiment can be manufactured by the above procedure.

### Third Embodiment

A third embodiment, which is still another embodiment of the present disclosure, will be described. The spur gear 1 in the third embodiment basically has the same structure as the spur gear 1 in the first embodiment and achieves the same effects. However, the spur gear 1 of the third embodiment is different from that of the first embodiment mainly in the structure of the carburized layer 31. The differences from the first embodiment will be described below.

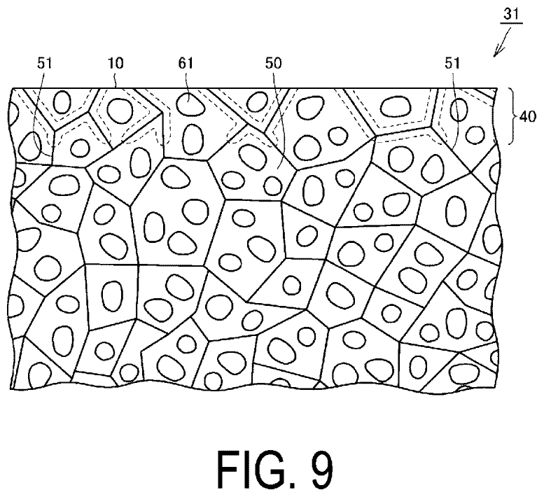

FIG. 9 is a schematic cross-sectional view illustrating a structure of a carburized layer of a spur gear according to the third embodiment. Referring to FIG. 9, in the carburized layer 31 of the spur gear 1 in the third embodiment, the maximum carbon concentration in the thickness direction of the carburized layer 31 is 1.1 mass % or more and 1.8 mass % or less. A large number of carbides 61 (cementite) are dispersed in the carburized layer 31. The maximum grain size of the carbide 61 in the cross section of the carburized layer 31 (cross section in FIG. 9) orthogonal to the outer circumferential surface 10, which is the surface of the spur gear 1, is, for example, 25 μm or less. Further, in the carburized layer 31, the grain size number is 11 or more. As the steel constituting the spur gear 1, for example, steel containing 0.35 mass % or more of molybdenum, for example, JIS standard SCM822H may be adopted.

As described above, by setting the maximum carbon concentration of the carburized layer 31 to be high and refining prior austenite crystal grains 50, the spur gear 1 of the third embodiment is a mechanical component having both durability against surface damage (for example, pitting resistance) and toughness at a high level. In the carburized layer 31, the area ratio of carbides 61 in the cross section orthogonal to outer circumferential surface 10 may be 3% or more and 30% or less.

Next, a method for manufacturing the spur gear 1 according to the third embodiment will be described. The spur gear 1 in the third embodiment can be manufactured basically in the same procedure as the spur gear 1 in the second embodiment. However, in the method of manufacturing the spur gear 1 of the third embodiment, the manufacturing method is partially different from that of the second embodiment in order to obtain the characteristic structure of the carburized layer 31. The differences from the second embodiment will be described below.

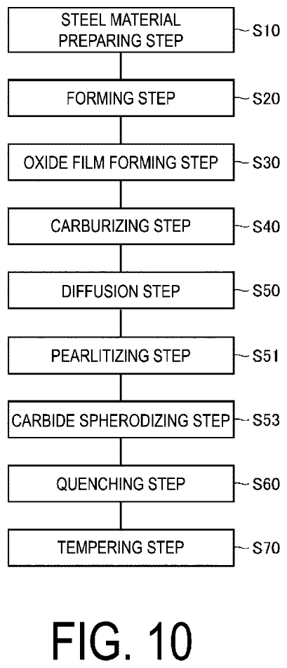

FIG. 10 is a flowchart schematically illustrating the method for manufacturing the spur gear according to the third embodiment. FIG. 10 is a diagram corresponding to FIG. 7 in the second embodiment.

Referring to FIG. 10, first, as in the second embodiment, the steel material preparing step is performed as the step S10. In the method of manufacturing the spur gear according to the third embodiment, a steel member made of JIS standard SCM822H may be prepared, for example.

Next, the step S20 is performed in the same manner as in the first and second embodiments. Thereafter, referring to FIGS. 10 and 7, the steps S30 to S51 are performed in the same manner as in the second embodiment. Here, in the step S40, the carburization time is set further longer as compared with the second embodiment, whereby the carburized layer 31 having a higher carbon concentration than those in the first and second embodiments is formed. Specifically, the carburized layer 31 is formed such that the maximum carbon concentration in the thickness direction is 1.1 mass % or more and 1.8 mass % or less.

Next, a carbide-spheroidizing step is performed as a step S53. In this step S53, the compact (spur gear 1) having the carburized layer 31 with a pearlitic structure is heated to a temperature range of the A1 transformation point or higher and then cooled to a temperature range lower than the A1 transformation point, whereby carbides contained in the carburized layer 31 are spheroidized. Specifically, referring to FIG. 8, heating and cooling are repeated as in the period from time t₂₂ to time t₃₀ in the second embodiment. As a result, lamellar carbides constituting the pearlitic structure are divided, a large number of nuclei of carbides are formed, and a large number of spherical carbides are formed by the growth of the nuclei. At this time, since the carbon content of the carburized layer 31 is higher than that in the second embodiment, the area ratio of the carbides 61 is higher than that in the second embodiment, and the steel structure in which the carbides 61 have a large grain size can be obtained. Further, as in the case of the second embodiment, the steel structure having fine prior austenite crystal grains 50 can be obtained.

Thereafter, the quenching step is performed as the step S60 in the same manner as in the second embodiment. Thereby, the spur gear 1 is quench-hardened, and the structure of the steel constituting the spur gear 1 becomes a state having a martensitic structure.

At this time, in the present embodiment, the maximum grain size of the carbides 61 in the carburized layer 31 in the cross section orthogonal to the outer circumferential surface 10, which is the surface of the compact (spur gear 1), is 25 μm or less. Further, the grain size number of the carburized layer 31 is 11 or more. In the carburized layer 31, the area ratio of the carbides 61 in the cross section of the carburized layer 31 orthogonal to the outer circumferential surface 10 may be 3% or more and 30% or less.

Thereafter, the tempering step is performed as the step S70 in the same manner as in the first and second embodiments. The spur gear 1 of the present embodiment can be manufactured by the above procedure.

### Fourth Embodiment

A fourth embodiment, which is still another embodiment of the present disclosure, will be described. The spur gear 1 in the fourth embodiment basically has the same structure as the spur gear 1 in the first embodiment and achieves the same effects. However, the spur gear 1 of the fourth embodiment is different from that of the first embodiment in that the carburized layer 31 contains nitrogen. The differences from the first embodiment will be described below.

Referring to FIG. 3, in the carburized layer 31 of the spur gear 1 in the fourth embodiment, the maximum nitrogen concentration in the thickness direction is 0.7 mass % or more and 1.2 mass % or less. In this manner, by causing nitrogen to infiltrate into the carburized layer 31 and ensuring an appropriate amount of retained austenite, the pitting resistance can be greatly improved. In the carburized layer 31, the maximum amount of retained austenite in the thickness direction may be 50 volume % or more and 70 volume % or less.

Next, a method for manufacturing the spur gear 1 according to the fourth embodiment will be described. The spur gear 1 in the fourth embodiment can be manufactured basically in the same procedure as the spur gear 1 in the first embodiment. However, in the method of manufacturing the spur gear 1 of the fourth embodiment, the manufacturing method is partially different from that of the first embodiment in order to introduce nitrogen into the carburized layer 31. The differences from the first embodiment will be described below.

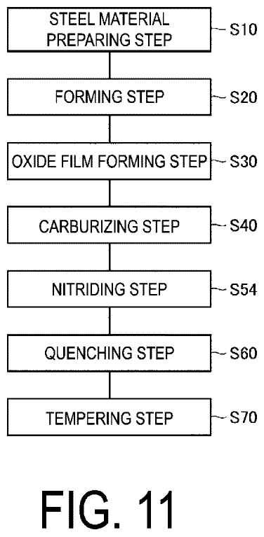

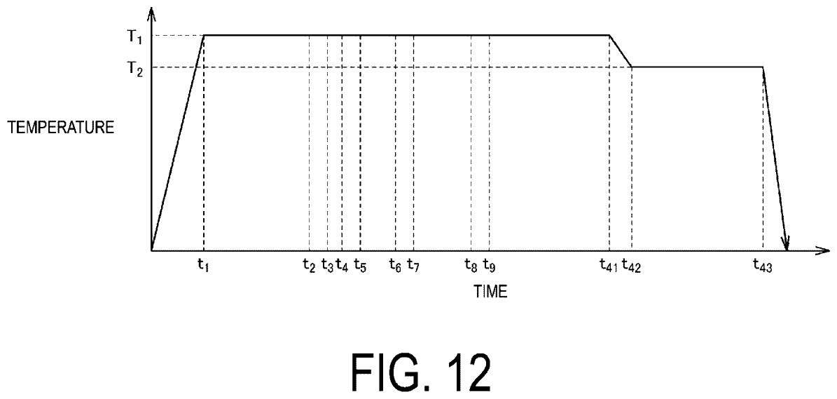

FIG. 11 is a flowchart schematically illustrating the method for manufacturing the spur gear according to the fourth embodiment. FIG. 12 is a diagram illustrating heat treatment performed in the method for manufacturing the spur gear according to the fourth embodiment. FIGS. 11 and 12 correspond to FIGS. 4 and 5 in the first embodiment.

Referring to FIG. 11, first, as in the first embodiment, the steel member preparing step is performed as the step S10. In the method for manufacturing the spur gear of the fourth embodiment, a steel material made of steel having the same component composition as that of the first embodiment is prepared.

Next, the step S20 is performed in the same manner as in the first embodiment. Thereafter, referring to FIGS. 11 and 12, the steps S30 to S40 (until time t₉ in FIG. 12) are performed in the same manner as in the first embodiment.

Next, a nitriding step is performed as a step S54. In the step S54, the compact (spur gear 1) is heated in a nitriding atmosphere to cause nitrogen to infiltrate into the carburized layer 31. Specifically, referring to FIG. 12, the compact (spur gear 1) on which the carburized layer 31 is formed is held at the temperature T₁ in a nitriding atmosphere from time t₉ to time t₄₁. As the nitriding atmosphere, for example, a mixed gas of nitrogen (N₂) and ammonia (NH₃) can be employed. The pressure of the atmosphere may be 100 kPa or less, and may be, for example, 40 kPa. Thus, nitrogen infiltrates into the carburized layer 31.

Thereafter, the spur gear 1 is cooled from the temperature T₁ to the temperature T₂ during a period from time t₄₁ to time t₄₂. Then, from time t₄₂ to time t₄₃, the spur gear 1 is held at the temperature T₂ in the nitriding atmosphere. Thus, nitrogen further infiltrates into the carburized layer 31.

Next, the quenching step is performed as the step S60. In the step S60, the compact (spur gear 1) subjected to the steps up to the step S54 is quench-hardened. Specifically, referring to FIG. 12, the spur gear 1 held in the nitriding atmosphere until time t₄₃ is cooled (rapidly cooled) to the temperature of the MS point or lower. Thereby, the spur gear 1 is quench-hardened, and the structure of the steel constituting the spur gear 1 becomes a state having a martensitic structure.

Thereafter, the tempering step is performed as the step S70 in the same manner as in the first embodiment. The spur gear 1 of the present embodiment can be manufactured by the above procedure.

### Fifth Embodiment

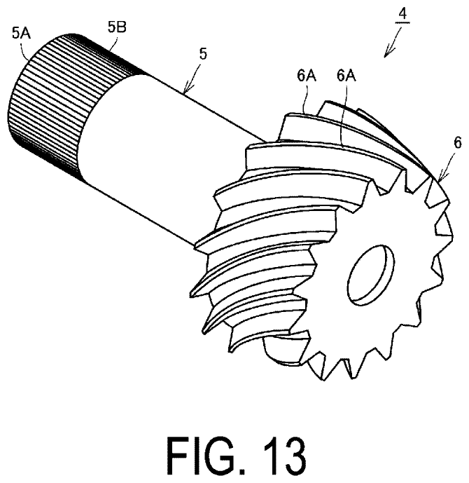

Next, as a fifth embodiment, an example in which the mechanical component of the present disclosure is applied to a bevel pinion will be described. FIG. 13 is a schematic perspective view illustrating an appearance of a bevel pinion.

Referring to FIG. 13, a bevel pinion 4 in the fifth embodiment includes a shaft portion 5 and a gear portion 6. The shaft portion 5 includes a spline portion 5A on one end portion 5B side. The spline portion 5B is a portion in which groove portions extending in the axial direction are formed on the outer circumferential surface at equal intervals over the entire circumference. The gear portion 6 is connected to an end portion of the shaft portion 5 on the opposite side to the one end portion 5A. The gear portion 6 has a truncated cone shape. In the region corresponding to the outer circumferential surface of the truncated cone shape (conical surface), teeth 6A are formed in a spiral shape over the entire circumference. The bevel pinion 4 can be used as a component constituting an axle of a wheel loader or a dump truck, which is a work machine, for example.

The bevel pinion 4 of the present embodiment is made of steel similar to that of the spur gear 1 of the first to fourth embodiments. The bevel pinion 4 is disposed to form an outer circumferential surface (surface) of the gear portion 6, and includes a carburized layer having a higher carbon concentration than other portions, as in the spur gear 1 of the first to fourth embodiments. As with the spur gear 1 in the first to fourth embodiments, the carburized layer includes a composite oxide film which is disposed to constitute the outer circumferential surface of the gear portion 6, which has a thickness of 1 μm or more and 25 μm or less, and which contains magnetite and hematite.

The bevel pinion 4 of the present embodiment has a configuration similar to that of the first to fourth embodiments described above, and thus is a mechanical component having improved durability by suppressing occurrence of white layer peeling. The bevel pinion 4 of the present embodiment can be manufactured in the same procedure as the spur gear 1 of the first to fourth embodiments.

### EXAMPLES

### (1) Effect on White Layer Peeling of Composite Oxide Film

An experiment was conducted to confirm the effect of suppressing the white layer peeling of the composite oxide film in the mechanical component of the present disclosure. The experimental procedure is as follows.

First, a compact having the shape of a test gear was manufactured, and heat treatment was performed in the same procedure as in the steps S30 to S70 described in the first embodiment, thereby manufacturing a test gear. At this time, the conditions of the oxide film forming step (S30) were changed to manufacture test gears in which the thickness of the composite oxide film was varied between 2 and 8 μm. For comparison, a test gear having no composite oxide film (the thickness of the composite oxide film was 0) was also manufactured by omitting the oxide film forming step (S30).

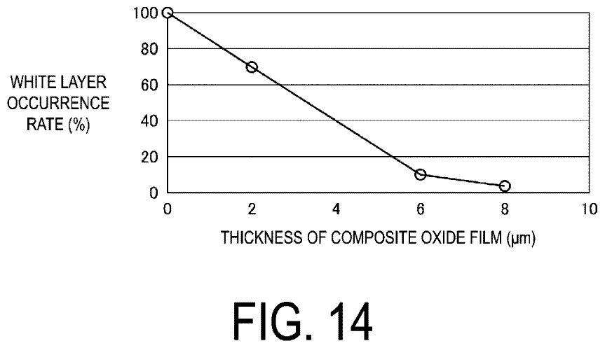

A gear (large gear) having a larger diameter than the test gear was separately prepared. Then, the test gear and the large gear were engaged with each other, the test gear was driven, and the gears were driven until pitching occurred on the surface of the test gear in a state where the large gear was driven. The rotational speed of the test gear was 2000 rpm, and the surface pressure of the contact portion between the gears was 220 to 260 kgf/mm². In addition, in order to cause the white layer more likely to occur, the temperature of lubricating oil was set higher than that in the normal use condition. After the test, the damaged portion was examined, and the incidence of the white layer was calculated. The test results are shown in FIG. 14.

In FIG. 14, the horizontal axis corresponds to the thickness of the composite oxide film containing magnetite and hematite. The vertical axis corresponds to the incidence of the white layer. Referring to FIG. 14, in the test gear having no composite oxide film (the thickness of the composite oxide film is 0), the incidence of white layer peeling is 100%. On the other hand, it can be seen that the white layer peeling is suppressed in the test gear in which the thickness of the composite oxide film is 1 μm or more. Specifically, it can be seen that the white layer occurrence rate is 70% or less when the thickness of the composite oxide film is 2 μm or more, 10% or less when the thickness of the composite oxide film is 6 μm or more, and 5% when the thickness of the composite oxide film is 8 μm or more. From this, it can be said that the thickness of the composite oxide film is effective when it is 1 μm or more, and it is more preferable to set the thickness to 2 μm or more, 6 μm or more, and further 8 μm or more.

### (2) Confirmation of Composition of Composite Oxide Film

An experiment was conducted to confirm the composition of the composite oxide film included in the mechanical component of the present disclosure. The experimental procedure is as follows.

First, a steel compact was manufactured, and heat treatment was performed in the same procedure as in the steps S30 to S70 described in the first embodiment, thereby manufacturing a sample of Example. On the other hand, for comparison, a steel compact similarly prepared was subjected to gas carburization and quenching (sample of Comparative Example). The gas carburization conditions were a carburizing time of 180 minutes and a diffusion time of 120 minutes. Then, thin film XRD (X-ray Diffraction) analysis was performed on the samples of Example and Comparative Example to identify oxides contained in the oxide films formed on the surfaces of the samples.

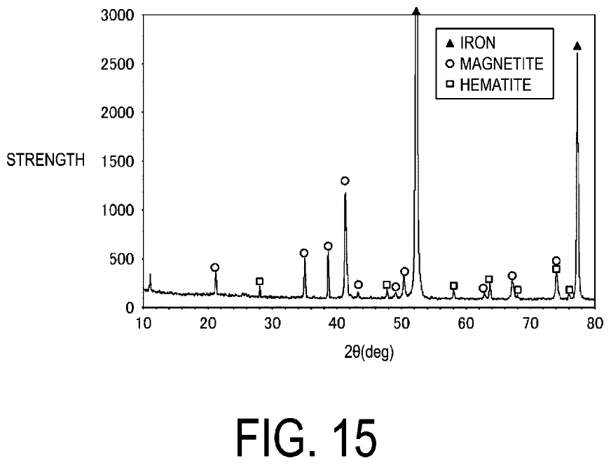

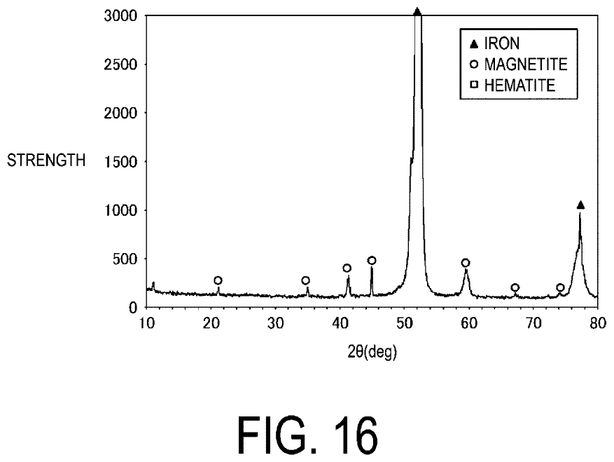

FIG. 15 is a diagram showing results of X-ray diffraction analysis of the composite oxide film in the sample of Example. FIG. 16 is a diagram showing results of X-ray diffraction analysis of an oxide film in a sample of Comparative Example formed by gas carburization. Referring to FIG. 15, it is confirmed that a composite oxide film containing magnetite and hematite is formed in the sample of Example. On the other hand, referring to FIG. 16, the presence of hematite is not confirmed in the sample of Comparative Example, and it is confirmed that an oxide film constituted of a magnetite single phase is formed.

### (3) Confirmation of Effect of Fine Carbide

An experiment was conducted to confirm the superiority of the mechanical component of the second embodiment (the mechanical component in which fine carbides are dispersed in the carburized layer). The experimental procedure is as follows.

A test gear was manufactured in the same manner as in the above-described (1) according to the procedure of the steps S10 to S70 of the second embodiment (Example). For comparison, a test gear was also manufactured by changing the heat treatment to gas carburization (Comparative Example). The gas carburization conditions were a carburizing time of 180 minutes and a diffusion time of 120 minutes. As steels constituting the test gears of Example and Comparative Example, steel A and steel B in Table 1 were adopted, respectively. In Table 1, the components other than the components shown are iron and inevitable impurities. Then, a large gear was prepared separately in the same manner as in the above (1), and by changing the surface pressure applied to the tooth surface, the number of times of engagement until the occurrence of pitting at each surface pressure was investigated (surface pressure strength test).

TABLE 1

| | C | Si | Mn | Cr | Mo | Nb |
|---|---|---|---|---|---|---|
| Steel A | 0.24 | 0.50 | 0.30 | 1.80 | — | 0.04 |
| Steel B | 0.18 | 0.25 | 0.80 | 1.00 | 0.15 | — |

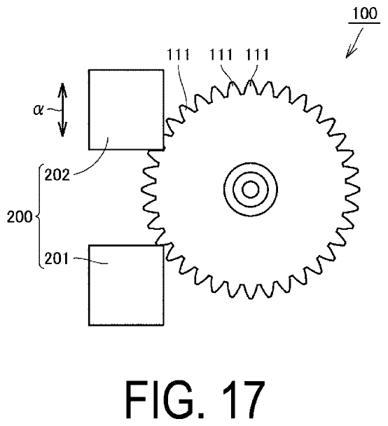

Further, test gears 100 of the above-described Example and Comparative Example were subjected to bending dedendum bending fatigue. FIG. 17 is a diagram illustrating a method of a dedendum bending fatigue test. Referring to FIG. 17, a test device 200 includes a fixing jig 201 and a swinging jig 202. In a state where the fixing jig 201 is in contact with one tooth 111 of the test gear 100 of each of Example and Comparative Example, the swinging jig 202 is brought into contact with another tooth 111, and the swinging jig 202 is swung along an arrow a, thereby repeatedly applying bending stress to the dedendum of the tooth 111. Then, the number of times of repetition of stress until the tooth 111 was broken was investigated. The frequency of the oscillation of the swinging jig 202 was set to 5 Hz, and the load applied to the tooth 111 was set to a range of 100 to 240 kgf/mm². When no breakage occurred at the time when the number of repetitions of stress was 4.0×10⁶, the test was stopped.

Further, an impact bending load was applied to the dedendum of the test gear of each of the above-described Example and Comparative Example, and the minimum load until breakage was investigated (dedendum bending impact test). The test was performed at room temperature. Furthermore, test pieces were prepared according to the procedure of the steps S10 to S70 of the second embodiment, and Charpy impact tests (see JIS standard Z2242) were performed. The shape of the test piece was a 10R notch. The test was performed at normal temperature (room temperature) and low temperature (−40° C.).

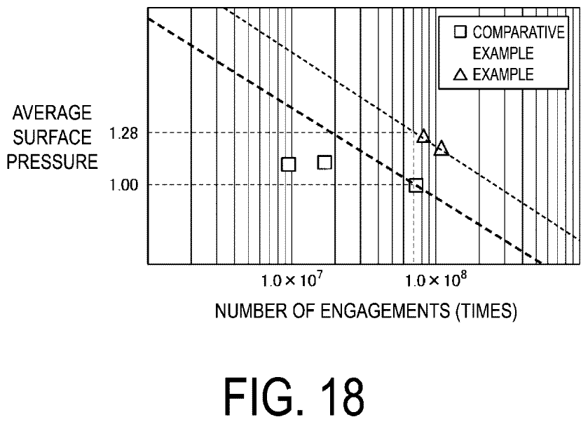

The test results will be described below. FIG. 18 is a diagram showing results of the surface pressure strength test. In FIG. 18, the horizontal axis corresponds to the number of times of engagement of the teeth, and the vertical axis corresponds to the average surface pressure applied to the tooth surface. Referring to FIG. 18, it is confirmed that when pitching occurs at the same number of times of engagement, the average surface pressure applied to the test gear of Example is higher than the average surface pressure applied to the test gear of Comparative Example. For example, the load at which pitching occurs when the number of times of engagement is 7.0×10⁷ is 1.28 in Example when the load in Comparative Example is 1.00. It is confirmed that the mechanical component of the second embodiment in which fine carbides are dispersed in the carburized layer is superior in pitting resistance to the mechanical component manufactured by the conventional gas carburization.

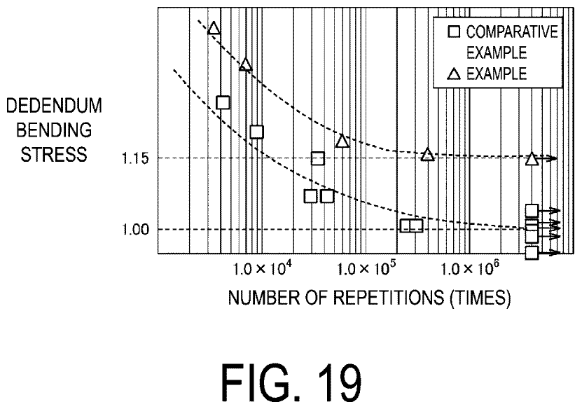

FIG. 19 is a diagram showing results of the dedendum bending fatigue test. In FIG. 19, the horizontal axis corresponds to the number of repetitions of stress, and the vertical axis corresponds to the dedendum bending stress, respectively. In FIG. 19, a data point corresponding to a test condition in which no breakage occurred at the time point when the number of repetitions of stress was 4.0×10⁶ times and the test was stopped is marked with an arrow. The vertical axis of FIG. 19 represents a relative value with respect to the stress at a point where a curve drawn along the test results of Comparative Example intersects a vertical line corresponding to the number of repetitions of stress of 4.0×10⁶, which is defined as 1.00.

Referring to FIG. 19, it is confirmed that, when the breakage occurs in the dedendum at the same number of repetitions, the dedendum bending stress applied to the test gear of Example is higher than the dedendum bending stress applied to the test gear of Comparative Example. For example, the bending stress at which the number of repetitions of stress reaches 4.0×10⁶ without breakage is 1.15 in Example when the bending stress in Comparative Example is 1.00. From this, it is confirmed that the mechanical component of the second embodiment in which fine carbides are dispersed in the carburized layer is superior in durability against the dedendum bending stress to the mechanical component manufactured by the conventional gas carburization.

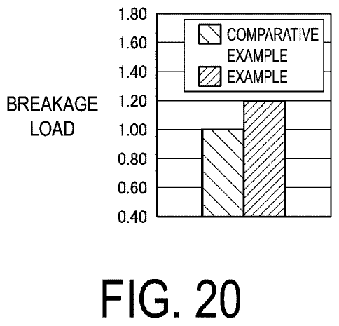

FIG. 20 is a diagram showing results of the dedendum bending impact test. The breakage load, which is the vertical axis of FIG. 20, is indicated as a relative value with the breakage load of Comparative Example being 1.00. Referring to FIG. 20, the breakage load in the dedendum bending impact test of Example is about 20% higher than that of Comparative Example. From this, it is confirmed that the mechanical component of the second embodiment in which fine carbides are dispersed in the carburized layer is superior in strength against the dedendum bending impact load to the mechanical component manufactured by the conventional gas carburization.

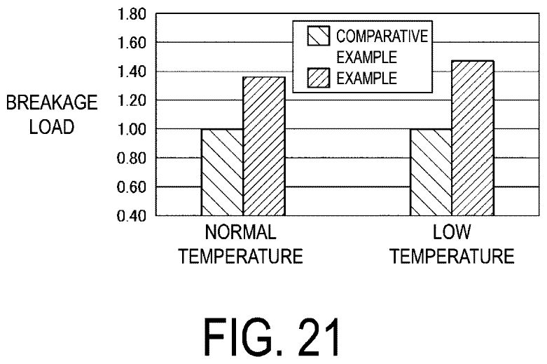

FIG. 21 is a diagram showing results of the Charpy impact test. The breakage load represented by the vertical axis of FIG. 21 is indicated by a relative value with the breakage load of Comparative Example being 1.00 for each of the conditions of normal temperature and low temperature. Referring to FIG. 21, the breakage load in the Charpy impact test of Example is significantly higher than that of Comparative Example. From this, it is confirmed that the mechanical component of the second embodiment in which fine carbides are dispersed in the carburized layer is excellent in toughness due to the effect of grain refinement, as compared with the mechanical component manufactured by the conventional gas carburization.

In the above-described embodiment, as an example of the mechanical component of the present disclosure, the spur gear constituting the transmission, the final drive, or the swing machinery of the work machine, and the bevel pinion constituting the axle have been described. However, the application of the mechanical component of the present disclosure is not limited thereto. For example, the mechanical component of the present disclosure is also applicable to a shaft constituting a final drive or a swing machinery of a work machine, a bevel gear or a ring gear constituting an axle, and the like.

It should be understood that the embodiment and the example disclosed herein is illustrative in all respects and is not restrictive in any respect. The scope of the present invention is not limited to the description given above, and is defined by the claims and intended to include all modifications within the meaning and scope equivalent to the claims.

### REFERENCE SIGNS LIST

1 Spur gear 2 Through hole 4 Bevel pinion 5 Shaft portion 5A End portion 5B Spline portion 6 Gear portion 6A Tooth 10 Outer circumferential surface 11 Tooth 20 Inner circumferential surface 31 Carburized layer 32 Base portion 40 Composite oxide film 41 Grain boundary oxidized region 50 Prior austenite grains 51 Grain boundary 61 Carbides 100 Test gear 111 Tooth 200 Test device 201 Fixing jig 202 Swinging jig A Central axis t_{A} Thickness t_{B} Thickness

1. A mechanical component made of steel containing 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, with the balance being iron and inevitable impurities, and having a martensitic structure, the mechanical component including a carburized layer disposed so as to constitute at least a part of a surface and having a higher carbon concentration than the other portion, wherein
the carburized layer includes a composite oxide film disposed so as to constitute the surface, having a thickness of 1 μm or more and 25 μm or less, and containing magnetite and hematite.

2. A mechanical component made of steel containing 0.12 mass % or more and 0.28 mass % or less of carbon, 0.15 mass % or more and 0.70 mass % or less of silicon, 0.20 mass % or more and 0.95 mass % or less of manganese, 0.85 mass % or more and 1.90 mass % or less of chromium, and at least one selected from the group consisting of 0.15 mass % or more and 0.45 mass % or less of molybdenum, 0.01 mass % or more and 2.00 mass % or less of nickel, and 0.04 mass % or more and 0.08 mass % or less of niobium, with the balance being iron and inevitable impurities, and having a martensitic structure, the mechanical component including a carburized layer disposed so as to constitute at least a part of a surface and having a higher carbon concentration than the other portion, wherein
the carburized layer includes a composite oxide film disposed so as to constitute the surface, having a thickness of 1 μm or more and 25 μm or less, and containing magnetite and hematite.

3. The mechanical component according to claim 1, wherein the carburized layer has a thickness of 500 μm or more.

4. The mechanical component according to claim 1, wherein a maximum carbon concentration in a thickness direction of the carburized layer is 0.6 mass % or more.

5. The mechanical component according to claim 1, wherein
in the carburized layer, a maximum carbon concentration in a thickness direction is 0.8 mass % or more and 1.2 mass % or less, and
a maximum grain size of carbides in a cross section orthogonal to the surface is 1 μm or less, and
a grain size number defined in JIS G0551 is 12 or more.

6. The mechanical component according to claim 1, wherein
in the carburized layer, a maximum carbon concentration in a thickness direction is 1.1 mass % or more and 1.8 mass % or less, and
a maximum grain size of carbides in a cross section orthogonal to the surface is 25 μm or less, and
a grain size number defined in JIS G0551 is 11 or more.

7. The mechanical component according to claim 1, wherein
in the carburized layer, a maximum nitrogen concentration in a thickness direction is 0.7 mass % or more and 1.2 mass % or less.

8. The mechanical component according to claim 1, wherein the mechanical component is a component constituting a transmission, an axle, a final drive, or a swing machinery of a work machine.

9. A method for manufacturing a mechanical component comprising:
preparing a steel material containing 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, with the balance being iron and inevitable impurities;
forming the steel material, thereby obtaining a compact;
heating the compact in an oxidizing atmosphere, thereby forming a composite oxide film containing magnetite and hematite on a surface of the compact;
heating the compact, on which the composite oxide film is formed, in a carburizing atmosphere at a pressure of 1 kPa or less, thereby forming, on the surface of the compact, a carburized layer having a higher carbon concentration than the other portion with a thickness thicker than the composite oxide film; and
quench-hardening the compact having the composite oxide film and the carburized layer formed thereon.

10. A method for manufacturing a mechanical component comprising:
preparing a steel material containing 0.12 mass % or more and 0.28 mass % or less of carbon, 0.15 mass % or more and 0.70 mass % or less of silicon, 0.20 mass % or more and 0.95 mass % or less of manganese, and 0.85 mass % or more and 1.90 mass % or less of chromium, and at least one selected from the group consisting of 0.15 mass % or more and 0.45 mass % or less of molybdenum, 0.01 mass % or more and 2.00 mass % or less of nickel, and 0.04 mass % or more and 0.08 mass % or less of niobium, with the balance being iron and inevitable impurities;
forming the steel material, thereby obtaining a compact;
heating the compact in an oxidizing atmosphere, thereby forming a composite oxide film containing magnetite and hematite on a surface of the compact;
heating the compact, on which the composite oxide film is formed, in a carburizing atmosphere at a pressure of 1 kPa or less, thereby forming, on the surface of the compact, a carburized layer having a higher carbon concentration than the other portion with a thickness thicker than the composite oxide film; and
quench-hardening the compact having the composite oxide film and the carburized layer formed thereon.

11. The method for manufacturing a mechanical component according to claim 9, wherein forming the composite oxide film and forming the carburized layer are alternately repeated a plurality of times.

12. The method for manufacturing a mechanical component according to claim 9, wherein
in the formation of the carburized layer, the carburized layer is formed such that a maximum carbon concentration in a thickness direction is 0.8 mass % or more and 1.2 mass % or less, the method further comprising:
before quench-hardening the compact, cooling the compact on which the carburized layer is formed from a temperature range of an A1 transformation point or higher to a temperature range lower than the A1 transformation point, thereby forming the carburized layer into a pearlitic structure; and
heating the compact having the carburized layer formed into the pearlitic structure to the temperature range of the A1 transformation point or higher and then cooling the compact to the temperature range lower than the A1 transformation point, thereby spheroidizing carbides contained in the carburized layer and refining crystal grains of the carburized layer, wherein
after quench-hardening the compact, a maximum grain size of the carbides in the carburized layer in a cross section orthogonal to the surface of the compact is 1 μm or less, and a grain size number of the carburized layer defined in JIS G0551 is 12 or more.

13. The method for manufacturing a mechanical component according to claim 9, wherein
in the formation of the carburized layer, the carburized layer is formed such that a maximum carbon concentration in a thickness direction is 1.1 mass % or more and 1.8 mass % or less; the method further comprising:
before quench-hardening the compact, cooling the compact on which the carburized layer is formed to a temperature range lower than the A1 transformation point, thereby forming the carburized layer into a pearlitic structure; and
heating the compact having the carburized layer formed into the pearlitic structure to a temperature range of the A1 transformation point or higher and then cooling the compact to the temperature range lower than the A1 transformation point, thereby spheroidizing carbides contained in the carburized layer, wherein
after quench-hardening the compact, a maximum grain size of the carbides in the carburized layer in a cross section orthogonal to the surface of the compact is 25 μm or less, and a grain size number of the carburized layer defined in JIS G0551 is 11 or more.

14. The method for manufacturing a mechanical component according to claim 9 further comprising:
before quench-hardening the compact, heating the compact in a nitriding atmosphere, thereby causing nitrogen to infiltrate into the carburized layer.

15. The mechanical component according to claim 2, wherein the carburized layer has a thickness of 500 μm or more.

16. The mechanical component according to claim 2, wherein a maximum carbon concentration in a thickness direction of the carburized layer is 0.6 mass % or more.

17. The mechanical component according to claim 2, wherein
in the carburized layer, a maximum carbon concentration in a thickness direction is 0.8 mass % or more and 1.2 mass % or less, and
a maximum grain size of carbides in a cross section orthogonal to the surface is 1 μm or less, and
a grain size number defined in JIS G0551 is 12 or more.

18. The mechanical component according to claim 2, wherein
in the carburized layer, a maximum carbon concentration in a thickness direction is 1.1 mass % or more and 1.8 mass % or less, and
a maximum grain size of carbides in a cross section orthogonal to the surface is 25 μm or less, and
a grain size number defined in JIS G0551 is 11 or more.

19. The mechanical component according to claim 2, wherein
in the carburized layer, a maximum nitrogen concentration in a thickness direction is 0.7 mass % or more and 1.2 mass % or less.

20. The mechanical component according to claim 2, wherein the mechanical component is a component constituting a transmission, an axle, a final drive, or a swing machinery of a work machine.
